(19) United States
(12) Patent Application Publication
(10) Pub. No.: US 2026/0073201 A1
(43) Pub. Date: Mar. 12, 2026

(54) POST-TRAINING QUANTIZATION FOR DIFFUSION TRANSFORMERS

(71) Applicant: Samsung Electronics Co., Ltd., Suwon-si (KR)

(72) Inventors: Mostafa EL-KHAMY, San Diego, CA (US); Qingfeng LIU, San Diego, CA (US); Sanghyun YI, Pasadena, CA (US)

(21) Appl. No.: 19/258,874

(22) Filed: Jul. 2, 2025

Related U.S. Application Data
(60) Provisional application No. 63/692,677, filed on Sep. 9, 2024.

(51) Int. Cl. G06N 3/0495; G06N 3/045

(52) U.S. Cl. CPC G06N 3/0495; G06N 3/045

(57) ABSTRACT

A technique for quantization in diffusion transformers is disclosed. A weight quantizer is configured to quantize a weight matrix of a layer in a diffusion transformer block to generate a quantized weight matrix. An activation quantizer is configured to quantize an activation matrix of the layer to generate a quantized activation matrix. A time-step quantizer is configured to estimate a quantization parameter based on at least one of the quantized weight matrix or the quantized activation matrix for a time step based on a per-step calibration set.

### CROSS-REFERENCE TO RELATED APPLICATIONS

This application claims the priority benefit under 35 U.S.C. § 119 (e) of U.S. Provisional Patent Application Ser. No. 63/692,677 filed on Sep. 9, 2024, the disclosure of which is incorporated by reference in its entirety as if fully set forth herein.

### TECHNICAL FIELD

The disclosure generally relates to generative artificial intelligence (AI). More particularly, the subject matter disclosed herein relates to quantization methods for diffusion transformers.

### BACKGROUND

The present background section is intended to provide context only, and the disclosure of any concept in this section does not constitute an admission that said concept is prior art.

Advances in data science, artificial intelligence (AI), and machine learning (ML) have led to transformative changes in technologies across various industries. Generative AI, a subfield of AI, uses generative models to generate new text, images, videos, or other media forms from the input which may be any combination of data types. Among the various generative models, diffusion transformers (DiT) have gained popularity due to their impressive results, especially realistic video of complex visual scenes.

The good performance of diffusion transformers is achieved thanks to many complex calculations in various computational blocks. These complex calculations require large memory storage and costly hardware circuits. One way to reduce memory and computational requirements which involve floating-point numbers is to employ quantization to convert the floating-point representation of data such as weights and activations in the various layers in the DiT blocks into integers with lower bit widths. However, quantization techniques for DiT blocks have several disadvantages, including complexity, long processing time due to quantization in inference phases, and low quality of video or images.

The above information disclosed in this Background section is only for enhancement of understanding of the background of the disclosure and therefore it may contain information that does not constitute prior art.

### SUMMARY

To overcome these issues, systems and methods are described herein for a technique of quantizing in layers in diffusion transformers. The technique aims at providing an efficient structure for quantizing weights and activations at low bit widths while maintaining high image and video quality comparable with non-quantized images and videos. The technique is therefore hardware-friendly and suitable for high-speed computing on a generative AI environment.

In an embodiment, a layer quantizer includes at least a weight quantizer, an activation quantizer, and a time-step quantizer. The weight quantizer is configured to quantize a weight matrix of a layer in a diffusion transformer block to generate a quantized weight matrix. The activation quantizer is configured to quantize an activation matrix of the layer to generate a quantized activation matrix. The time-step quantizer is configured to estimate a quantization parameter based on at least one of the quantized weight matrix or the quantized activation matrix for a time step based on a per-step calibration set.

### BRIEF DESCRIPTION OF THE DRAWINGS

In the following section, the aspects of the subject matter disclosed herein will be described with reference to exemplary embodiments illustrated in the figures, in which:

FIG. 1 is a block diagram illustrating a system using a DiT block according to an embodiment.

FIG. 2 is a diagram illustrating a processing system according to an embodiment.

FIG. 3 is a diagram illustrating an arrangement of quantization processing according to an embodiment.

FIG. 4 is a diagram illustrating a weight/activation quantizer according to an embodiment.

FIG. 5 is a diagram illustrating a smooth quantizer according to an embodiment.

FIG. 6 is a diagram illustrating a representation of a time-step quantization according to an embodiment.

FIG. 7 is a flowchart illustrating a process of quantization according to an embodiment.

FIG. 8 is a diagram illustrating a system of generating a video using the DiT with post-training quantization (PTQ) according to an embodiment.

FIG. 9 is flowchart illustrating a process of implementing a video generation using the DiT with PTQ according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” describes in general any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

As used herein, the term “solid-state” in the context of storage refers to a storage technology that uses integrated circuits, instead of moving parts (e.g., spinning disks, platters, read/write heads) to store data. The term “flash memory” refers to a type of non-volatile memory which retains data even when power is removed. It is commonly used in solid-state drives (SSDs). There are two types of flash memory: NAND flash and NOR flash. The NAND flash memory has high storage density and lower cost per bit and is suitable for SSDs, mobile applications. The NOR flash is optimized for random access and is often used in applications requiring fast code execution.

As used herein, the term “transformer” describes in general a deep learning architecture based on an attention mechanism, in which a text is converted into numerical representations to be contextualized such that eventually more significant inputs are retained while poor information is discarded. The “diffusion transformer” refers to a class of diffusion models that are based on the transformer architecture. Diffusion-based models learn to transform Gaussian noise into data samples through a step-by-step denoising process.

As used herein, the term “quantization” describes in general a process or circuit that convert a set of numbers represented by a floating-point format into a set of numbers represented by an integer format. This operation results in a smaller storage size, fast computation, and improve portability. The floating-point number format may be any suitable format used in the diffusion transformer block. Examples of the floating-point format are 32-bit single-precision floating-point numbers (FP32), 16-bit half precision floating-point numbers (FP16). The integer number format is any integer format suitable for use in layers in the diffusion transformer block. Examples of the integer format includes 8-bit integer (INT8) and 4-bit integer (INT4).

As used herein, the term “post-training quantization (PTQ)” describes in general a quantization process that takes place after training the machine learning model including layers in the DiT. This is done to achieve efficiency, reduce hardware costs, and reduce computation time.

As used herein, the term “calibration” describes in general a process of determining the optimal quantization parameters, such as scaling factors and zero points, for converting a floating-point number to an integer number. The calibration procedure uses a representative dataset (calibration data) to collect statistics about the model's internal activations and weights, and then using those statistics to set the quantization parameters. The calibration data set is selected to be representative of the data being used at the inputs of the DiT block.

In an embodiment, a layer quantizer includes at least a weight quantizer, an activation quantizer, and a time-step quantizer. The weight quantizer is configured to quantize a weight matrix of a layer in a diffusion transformer block to generate a quantized weight matrix. The activation quantizer is configured to quantize an activation matrix of the layer to generate a quantized activation matrix. The time-step quantizer is configured to estimate a quantization parameter based on at least one of the quantized weight matrix or the quantized activation matrix for a time step based on a per-step calibration set. The weight and activation quantizers quantize the weight and activation matrices, respectively, in a post-training quantization (PTQ) during a calibration period different from an inference period. The quantization therefore is not performed during the run-time of inference and does not take up processing time. The layer quantizer may further include a smooth quantizer. The smooth quantization helps smooth out any large variations of the quantization parameters across the channels. The time-step quantizer helps reduce the effects of timestep variance in activation distributions. The smooth quantizer is configured to smooth a weight value in the weight matrix and an activation value in the activation matrix to generate a smoothed weight value and a smoothed activation value.

The layer quantizer may use several combinations of the above quantizers including a basic combination of the weight quantizer and the activation quantizer, the basic combination plus the smooth quantizer, the basic combination plus the time-step quantizer, or the basic combination plus the smooth quantizer and the time-step quantizer. When the smooth quantizer is used, it will be used before using the weight quantizer and the activation quantizer. In other words, after the smooth quantizer operates on the weight matrix and the activation matrix, the weight quantizer quantizes the weight matrix having the smoothed weight value to generate a quantized weight matrix and the activation quantizer quantizes the activation matrix having the smoothed activation value to generate a quantized activation matrix.

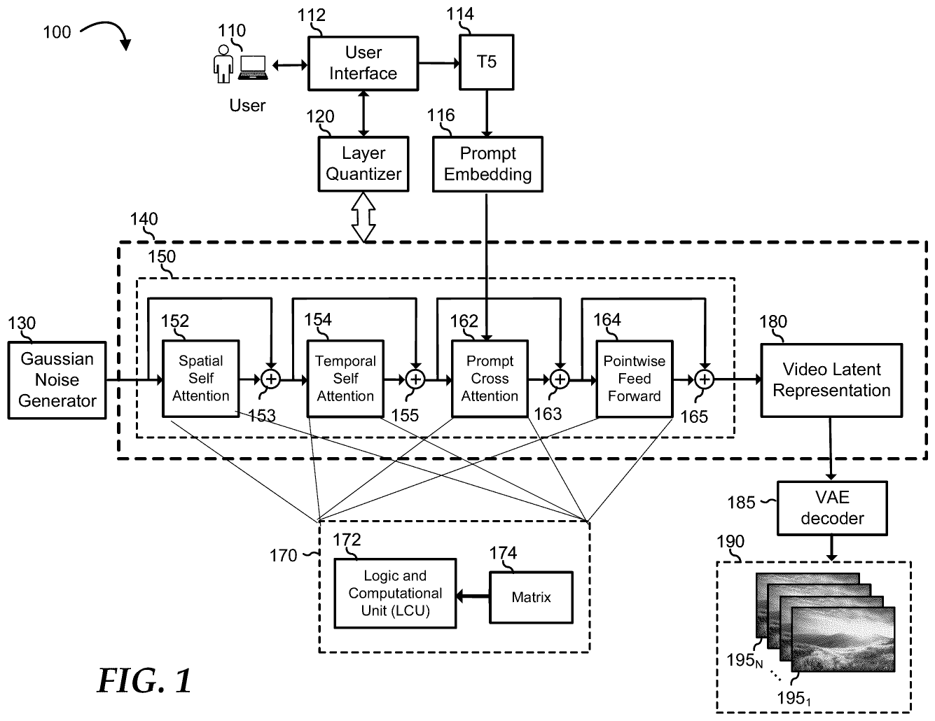

FIG. 1 is a block diagram illustrating a system 100 using a diffusion transformer (DiT) block according to an embodiment. The system 100 includes a user interface 112, a text-to-text transfer transformer (T5) model 114, a prompt embedding module 116, a layer quantizer 120, a Gaussian noise generator 130, a space-time diffusion transformer (STDiT) 140, a video latent representation layer or module 180, a variational autoencoder (VAE) decoder 185, and a sequence 190 of video frames. The system may include more or less than the above components.

The user interface 112 is an application that allows a user 110 to interact with the system 100. It provides interface typically through graphical display on a display screen or monitor. Through the interface, the user 110 may enter inputs via input devices such as mouse, keyboard, stylus, haptics, microphone, image sensor, or any other input means. The user interface 112 also generates outputs to the display screen, a printer, a speaker, or any other output means. In one embodiment, the user interface 112 receives input from the user 110 and generates output to the T5 model 114, typically in a form of text strings. The text strings may be prompts used to generate a sequence of images or a video of image scene. The T5 model 114 is configured to unify text-to-text format from various natural language (NLP) tasks such as translation, summarization, query and answer, and classification. In one embodiment, the T5 model 114 is a large language model (LLM) trained on a massive corpus of text to learn general language understanding. The T5 model 114 receives from the user interface 112 input strings of text and generates output strings of text in a unified format. In one embodiment, the text strings are prompts used to describe a video image scene.

The prompt embedding module 116 receives the text strings representing prompts from the T5 model 114 and converts the prompts into an embedding, which may be a numerical representation of the text. The embedding may be a vector of numbers that captures the semantic of the prompts, including the intent. The output of the prompt embedding module 116 goes to a prompt cross attention module 162 in the STDiT 140.

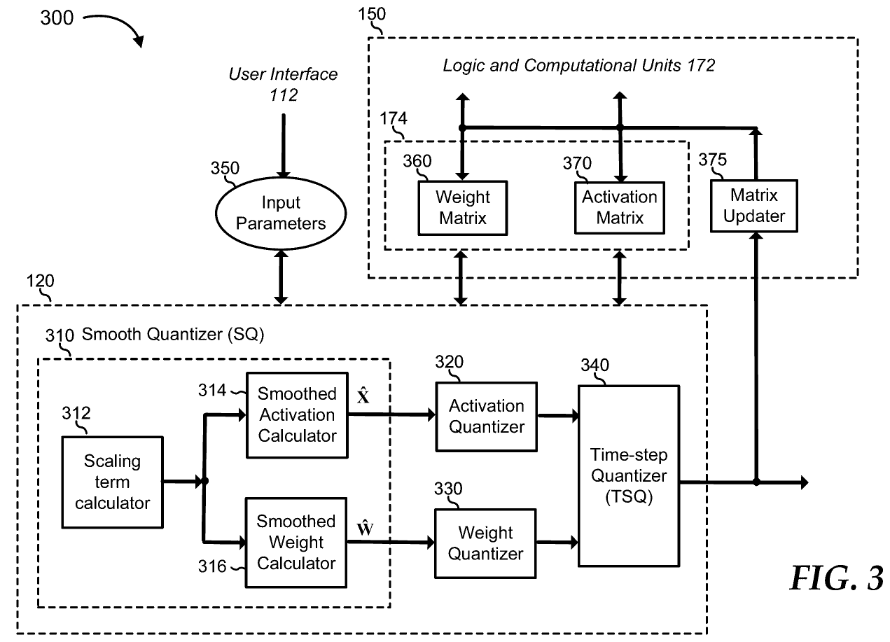

The layer quantizer 120 is configured to perform post-train quantization for the layers in the STDiT 140. It will be described further in FIG. 3.

The Gaussian noise generator 130 is configured to gradually introduce noise to transform data samples into having a Gaussian distribution. The gradual introduction of noise is performed as part of an iterative process in the diffusion process. The STDiT 140 includes a set 150 of linear layers or modules and a video latent representation layer or module 180. The set 150 of linear layers receives the Gaussian noise data and transform into the target image or video. This is performed by reversing the diffusion process through the set 150 of linear layers. The set 150 includes four linear layers: a spatial self-attention layer 152, a temporal self-attention layer 154, a prompt cross-attention layer 162, and a pointwise feed forward layer 164. The layers 152, 154, 163, and 165 have adders 153, 155, 163, and 165, respectively, at the respective outputs. The set 150 of linear layers may include more or less than the above components,

The spatial self-attention layer 152 is configured to pay attention to tokens or image patches or pixel features that may be more relevant than others in the context of the images as guided by the prompts. The relevancy is spatial which is related to the regions, segments, patches, or pixels in the image. The adder 153 adds the output of the spatial self-attention layer 152 and its input to produce an output to the next layer. This is based on the concept of residual learning which allows the input to a layer to bypass the layer's operations and be added directly to the layer's output. The temporal self-attention layer 154 is configured to pay attention to temporal aspects of tokens or image patches or pixel features that may be more relevant than others in the context of the images as guided by the prompts. The relevancy is temporal which is related to the images in the sequence. The adder 155 adds the output of the temporal self-attention layer 154 and its input to produce an output to the next layer. The prompt cross-attention layer 162 is configured to process the prompt embeddings from the prompt embedding module 116 and correlate the textual prompts to image or pixel features based on an understanding of the text. This may involve analyzing the words in the text and associate an image features with the analyzed words. a mechanism that allows the model to interact with and understand the text prompt while generating an image. The adder 163 adds the output of the prompt cross-attention layer 162 and its input to produce an output to the next layer. The pointwise feed forward layer 164 is configured to refine token representations in the various layers. In one embodiment, it includes a two-layer structure with a non-linear activation. The adder 165 adds the output of the pointwise feed forward layer 164 and its input to produce an output to the video latent representation layer or module 180.

The four layers 152, 154, 162, and 164 have similar structures represented by a structure 170. The structure 170 exists in each of the four layers 152, 154, 162, and 164. For simplicity, only one structure labeled 170 is shown. The structure 170 includes a logic and computational unit (LCU) 172 and a matrix 170. The LCU 172 includes logic and computational functionalities to perform various logic and computational operations such as add, subtract, multiply, divide, softmax, absolute function. The matrix 174 represents a vector or two-dimensional (2D) matrix that may contain neural network matrices including weight or activation parameters.

The video latent representation 180 is a compressed representation of data points that maintain only relevant features of the input data. It is a compressed, often lower-dimensional, abstract representation of data that is learned by the set 150 of linear layers. It's a way to represent data in a more compact and meaningful form, where similar data points are grouped together in the latent space.

The VAE decoder 185 is configured to reconstruct or generate new data from the video latent representation 180. It is in essence the reverse of the encoder, which compresses the input data into the latent space representation 180. The VAE decoder 185 generates the sequence 190 of video frames. In the context of generative AI, the sequence 190 is generated from a starting image and guided by the prompts processed by the T5 module 114.

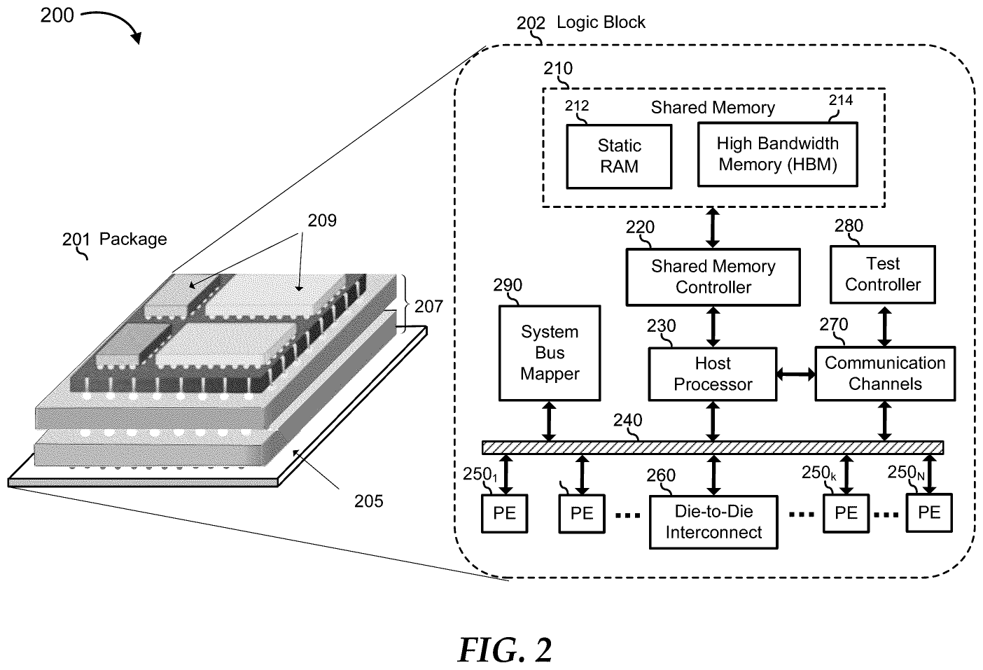

FIG. 2 is a diagram illustrating a processing system 200 according to an embodiment. The processing system 200 is configured to process the data and perform computations for various layers in the STDiT 140. It may include a physical package 201 and a logic block 202. It represents a system using High Bandwidth Memory (HBM) although this may not be necessary. The package 201 may include a base die 205 and a stack of memory dies 207. The logic block 202 represents the components in the physical package 201. It may include a shared memory 210, a shared memory controller 220, a host processor 230, a bus 240, N processing elements (PEs) 250ₖ's (k=1, . . . , N), a die-to-die (D2D) interconnect 260, communication channels 270, a test controller 280, and a system bus mapper 290. The processing system 200 may include more or less than the above components. In addition, the processing system 200 may include components that are packaged or arranged different that the above.

The processing system 200 may be fabricated in a system in a package or system-in-package (SIP) which may include multiple components, digital and/or analog, passive and/or active, including chips, modules. It combines all these components in a single package to perform the functions of an entire system. It may be part or a large system which includes several SIPs. In one embodiment, it may include several dies stacked on each other to form a 3-D package. The base die 205 may be configured to be at the base of the package and integrate heterogenous components including processors, special circuits, communication channels, and memories. The stack 207 may include several memories dies that form a 3-D stack as part of an HBM design to offer high bandwidth, low latency, low power consumption, and high storage capacity to meet the demands of high-performance computing applications such as AI, ML, DIT, graphics processing, neural computations, signal and image processing. Each die may include components 209. The components 209 may include logic circuits, processing elements, volatile memory circuits, and/or non-volatile memory circuits such as solid-state drive (SSD) or flash NAND devices. The stack 207 has a wide memory bus. For example, a stack of four DRAM dies may have two 128-bit channels per die to provide a memory bus width of 1,024 bits. Multiple stacks may be combined to provide an even wider bus. The HBM stack 207 may also have processing-in-memory (PIM) capability.

The shared memory 210 may be shared by multiple devices including the host processor 230 and the N PEs 250ₖ's (k=1, . . . , N). It may include a shared static random-access memory (SRAM) 212 and an HBM 214. The SRAM 212 includes volatile memories for fast access. It may also include register files or first-in-first-out (FIFO) structures. It may have buffered input/output interfaces to allow access from multiple devices. In one embodiment, for AI and/or ML applications, the shared SRAM 212 may be configured to store temporary weight and activation data. It may also be used for preloading kernel binaries, collecting or buffering partial reduction data from neighboring HBM modules or packages. The HBM 214 represents the stack 207 in the package 201. The shared memory controller 220 controls the shared memory 210 including the SRAM and HBM control such as read/write controls, row and column addresses, pre-charge control, and bank select.

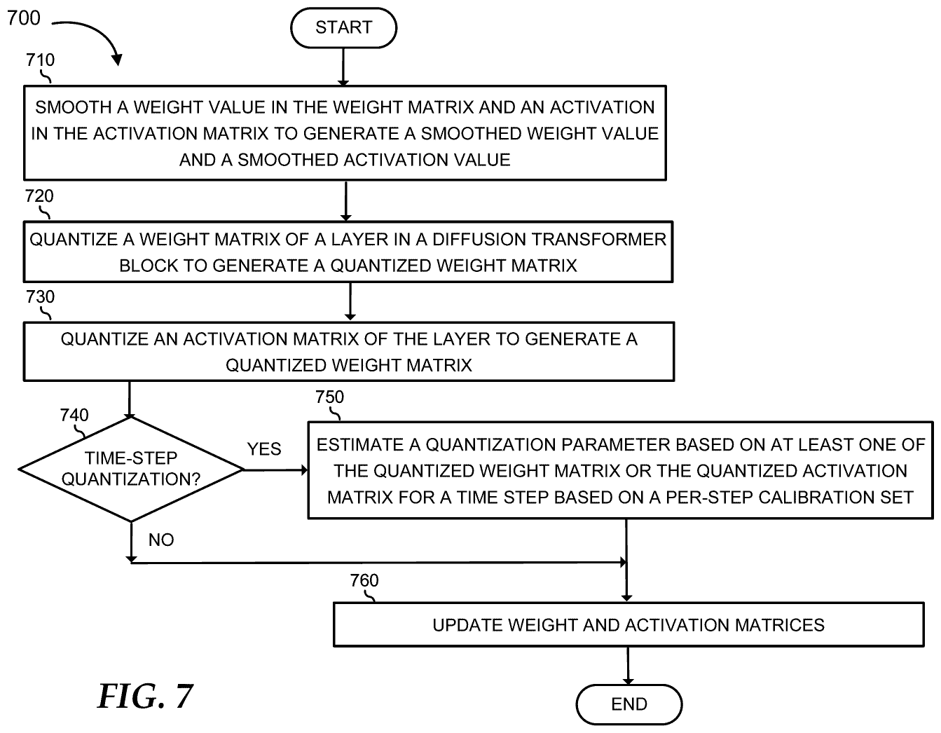

The host processor 230 performs the management functions for the shared memory 210 and the processing operations within itself and the PEs 250ₖ's (k=1, . . . , N). It may communicate with one or more PEs 250ₖ's via the bus 240 and/or the communication channel 270. It may control the PEs 250ₖ's to perform assigned tasks. The bus 240 is connected to the host processor 230, the N PEs 250ₖ's (k=1, . . . , N), the D2D interconnect 260, the communication channels 270, and the system bus mapper 290. It allows components to communicate with one another. It may transmit and receive data, addresses, and commands. The N PEs 250ₖ's (k=1, . . . , N) include computational resources that perform computations or calculating operations for the assigned tasks. They may operate asynchronously or synchronously under the control of the host processor 230. They have their own private memories that contain instructions or programs and data. Any one of the PEs is configured to execute its own programs or instructions. In the following, for clarity, the index k in multiple PEs 250ₖ's may be dropped. In one embodiment, the PEs 250ₖ's (k=1, . . . , N) may work together in a parallel mode where each PE is assigned a task. For example, each of the modules or layers 152, 154, 162, 164, and 180 shown in FIG. 1 may be assigned to one or more PEs. The private memory in each PE may store program or instructions that, when executed by the executing unit in the PE, perform quantization as described in the following and the flowchart shown in FIG. 7. In some embodiments, the host processor 230 may execute a program or instructions stored in the shared memory 210 to perform operations described in the following including the flowchart shown in FIG. 7.

The D2D interconnect 260 provides circuit interfaces for dies integrated within close proximity in the package 201. The D2D interconnect 260 facilitates modular design, improves signal integrity, increases bandwidth. In one embodiment, the D2D interconnect 260 may include at least one of Universal Chiplet Interconnect Express (UCIe), Advanced Interface Bus (AIB), or Bunch of Wires (BoW). The communication channels 270 include channels that support communication and/or data transfers. In one embodiment, the communication channels 270 may include direct memory access (DMA) channels, through silicon via (TSV) channels, Ultra Accelerator Link (UALink). The test controller 280 controls the testing of the SIP 201. This may include a core die test block in the shared HBM 214, Memory Built-in Self-Test (MBIST), circuits to support IEEE1500 standard, and D2D loopback control. It may also include debugging features, performance monitor, Joint Test Action Group (JTAG) support, tracing instructions and data, and telemetry support. The system bus mapper 290 maps the signals to a system bus interface to allows interconnections between various HBM packages.

FIG. 3 is a diagram illustrating an arrangement 300 of quantization processing according to an embodiment. The arrangement 300 includes input parameters 350, the set 150 of linear layers, and the layer quantizer 120 shown in FIG. 1. The arrangement 300 may be implemented by the host processor 230 and/or the PEs 250k's (k=1, . . . , N) shown in FIG. 1. It may also be implemented by circuits with dedicated hardware components, or a combination of hardware circuits and software processing functions. The arrangement 300 may include more or less than the above components.

The set 150 of linear layers include the matrices 174 shown in FIG. 1 and a matrix updater 375. The set 150 also includes the LCU 172 but for clarity it is not shown. The LCU 172 may include computational functions such as matrix multiplications, softmax function, square root, absolute function, etc. The matrices 174 include at least a weight matrix 360 and the activation matrix 370. The weight matrix 360 and the activation matrix 370 are two matrices that are used in each of the layers 152, 154, 162, and 164 shown in FIG. 1. They are part of the deep learning layers including neural networks. A layer may have multiple weight matrices and/or activation matrices, but for simplicity and clarity, only one weight matrix 360 and one activation matrix 370 are shown. In one embodiment, initially the weight matrix 360 and the activation matrix 370 contain floating-point values, either FP32 or FP16. These values will be quantized by the layer quantizer 120.

The matrix updater 375 receives the quantization results from the layer quantizer 120 and updates the weight matrix 360 and the activation matrix 370 accordingly. Since the bit lengths/widths of the quantized values are smaller than those of FP32 or FP16, the updating will take care of fitting the values into the corresponding array elements or memory locations. For example, the array may be re-organized and the new format will be recorded so that subsequent calculations will be based on the new integer format.

The input parameters 350 include parameters or variables that are used in the layer quantizer 120. Examples of these parameters include the bit width (e.g., 4, 8) of the integer format for the quantization, the number of time steps in the time-step quantizer (to be described later), the selection number to select the integer format (e.g., 0 for INT4, 1 for INT8), the selection code to select the type of quantization (e.g., smooth quantization, channel-wise quantization of weight matrices). The input parameters 350 are provided from the user interface 112. They may be entered by the user 110 or retrieved from an input document. or from a configuration record. The bit width may be one of 4, 6, 8, or 16, but 8 is the most popular value.

The layer quantizer 120 includes a smooth quantizer 310, an activation quantizer 320, an weight quantizer 330, and a time-step quantizer (TSQ) 340. The activation quantizer 320 and the weight quantizer 330 are two modules or units that perform the quantization. The smooth quantizer (SQ) 310 prepares or smooths the matrix values in the weight matrix 360 and the activation matrix 370 prior to the weight quantizer 320 and the activation quantizer 330. The time-step quantizer 340 performs the quantization over a number of time steps.

The smooth quantizer 310 is configured to solve the difficulty with the quantization of the activation matrix 370 when the number of parameters in the processing chain becomes large. In these situations, some values of in the activation matrix 370 may become quite large. These few outliers may cause problems when quantization is performed because they dominate the quantization range and leave only a few bits for most other values. Though mainly activations exhibit this behavior, to spread the effect of the outliers across the channel, a smoothing operation may be performed for both the activations and the weights. The smooth quantizer 310 is optional and may be selected or enabled through the input parameters 350. The smooth quantizer 310 is configured to smooth a weight value in the weight matrix W and an activation value in the activation matrix X to generate a smoothed weight value and a smoothed activation value as follows:

Let X and W be the activation matrix and the weight matrix, respectively. Let \hat{X} and Ŵ be the smoothed X and W. The smoothed \hat{X} and Ŵ are computed as follows. First, compute the SQ scale term sᵢ where i is the channel index. Then, compute the smoothed \hat{X} and Ŵ.

$$\begin{matrix}{s}_{i} = \frac{{max ( \vert {X}_{i} \vert )}^{α}}{{max ( \vert {W}_{i} \vert )}^{1 - α}} & ( 1 ) \\ \hat{X} = X \cdot {diag ( s )}^{- 1} & ( 2 ) \\ \hat{W} = diag ( s ) \cdot W & ( 3 )\end{matrix}$$

The SQ 310 includes a scaling term calculator 312, a smoothed activation calculator 314, and a smoothed weight calculator 316. The scaling term calculator 312 calculates the scaling term sᵢ according to equation (1). It is based on a ratio between an activation absolute maximum, max (|Xᵢ|)^{α}, and a weight absolute maximum, max(|Wᵢ|)^{α}. The numerator uses the activation matrix and the denominator uses the weight matrix. The smoothed activation calculator 314 calculates the smoothed activation value \hat{X} based on the activation X and an inverse of the scaling term, diag(s)⁻¹, according to equation (2). The smoothed weight calculator 316 calculates the smoothed weight value Ŵ based on the weight W and the scaling term, diag(s)⁻¹, according to equation (3).

The activation quantizer 320 configured to quantize an activation matrix of a layer in a diffusion transformer block. If the SQ 310 is enabled, the activation quantizer 320 quantizes the activation matrix \hat{X} having the smoothed activation value to generate a quantized activation matrix. If the SQ 310 is not enabled, the activation quantizer 320 quantizes the activation matrix X to generate a quantized activation matrix.

The weight quantizer 330 configured to quantize a weight matrix of a layer in a diffusion transformer block. If the SQ 310 is enabled, the weight quantizer 330 quantizes the weight matrix \hat{X} having the smoothed weight value to generate a quantized weight matrix. If the SQ 310 is not enabled, the weight quantizer 320 quantizes the weight matrix X to generate a quantized weight matrix.

The time-step quantizer (TSQ) 340 is configured to estimate a quantization parameter based on at least one of the quantized weight matrix or the quantized activation matrix for a time step based on a per-step calibration set. The time step is grouped into one or more ranges in which the quantization parameter is estimated.

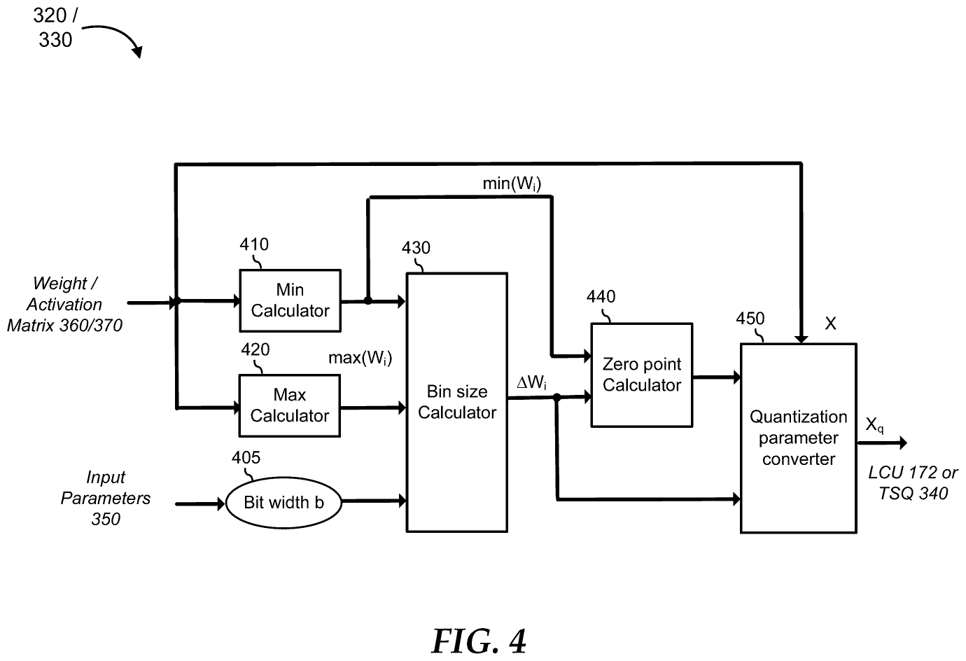

FIG. 4 is a diagram illustrating an activation/weight quantizer 320/330 according to an embodiment. The activation quantizer 320 and the weight quantizer 330 share a common structure and therefore it is convenient to illustrate in one figure. The activation/weight quantizer 320/330 includes a maximum calculator 410, a minimum calculator 420, a bin size calculator 430, a zero-point calculator 440, and a quantization parameter converter 450. The activation/weight quantizer 320/330 may include more or less than the above components.

Quantization is a process to convert a floating-point number with long bit width (16 for FP16 and 32 for FP32) to an integer number with smaller bit width (4 for TNT4, 8 for INT8). Due to reduction in the range of representation, quantization leads to loss of precision and/or accuracy. But the huge advantages include faster computations and reduction in storage. The quantization follows a basic procedure of calculating the range, or the bin size, of the floating-point number and a zero point, where i is the channel index. This bin size is calculated by taking the difference between the maximum value and the minimum value and divided by the range of the integer number. The zero point is determined by dividing the minimum value by the bin size.

For the channel wise (CW) quantization of the weight matrix to mitigate quantization errors arising from CW variance, the bin size ΔWᵢ and zero point z_{Wi} where i is the channel index are determined. The calculations are as follows:

$$\begin{matrix}Δ {W}_{i} = \frac{max ( {W}_{i} ) - min ( {W}_{i} )}{{2}^{b}} & ( 4 ) \\ {z}_{Wi} = \frac{min ( {W}_{i} )}{Δ {W}_{i}} & ( 5 )\end{matrix}$$

After the bin size ΔWᵢ and the zero point z_{Wi} are calculated, the quantized integer number W_{q} of the floating-point number W is determined by:

$${W}_{o} = [ \frac{W}{Δ {W}_{i}} + {z}_{Wi} ] \qquad ( 6 )$$

Equations (4), (5), and (6) are merely illustrative of one way to quantize a floating-point number to an integer number. Some embodiments may use different formulations.

For the activation quantization, a tensor-wise (TW) quantization of the activation matrix is performed. While dynamic token-wise quantization is widely used for transformer models, it is not feasible to estimate statistics to cover the variance of each token activation during inference in a static manner due to the heterogeneity across inference samples. Instead, the simplest method is to estimate the minimum and maximum values of activations tensor-wise. The bin size ΔX and zero points z_{X} for TW quantization of an activation matrix are scalar values. The calculations of ΔX, z_{X} and X_{q} are similar to the above equations (4), (5) and (6).

The minimum calculator 410 receives values of the weight matrix 360 or the activation matrix 370 and determines the minimum value of the values in the matrix W, min (Wᵢ) or the matrix X, min (X). The maximum calculator 420 receives values of the weight matrix 360 or the activation matrix 370 and determines the maximum value of the values in the matrix W, max(Wᵢ) or the matrix X, max(X). The bin size calculator 430 receives a bit width b 405 from the input parameters 350 and calculates the bin size ΔWᵢ based on equation (4), or similarly, ΔX. The zero-point calculator 440 calculates the zero point based on equation (5). The quantization parameter converter 450 determines the quantized integer number W_{q} based on equation (6).

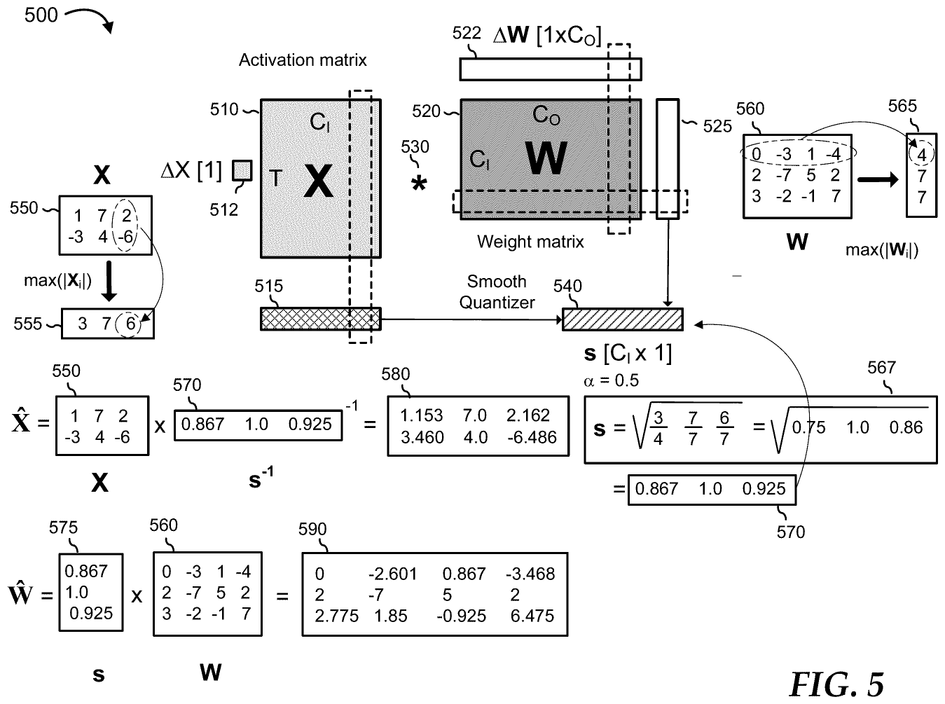

FIG. 5 is a diagram illustrating an operation 500 for the smooth quantization by the smooth quantizer 310 shown in FIG. 3 according to an embodiment. The operation 500 operates on an activation matrix 510 and a weight matrix 520 to produce a scale term s 540 which will be used to smooth the activation matrix 510 and the weight matrix 520. The scale term s 540 and the smoothing operation are described in FIG. 3 and equations (1), (2), and (3). Numerical examples are provided to illustrate the operation.

The activation matrix 510 has a dimension or shape T×C_{I}. A maximum operation operates on the column of the activation matrix 510 to produce a row vector 515. A single element 512 represents an element of the matrix 510. To determine the scale term sᵢ in equation (1), the maximum value of the absolute values of the activation values in the matrix 510 for each channel or column is determined to obtain the numerator. The denominator will be obtained later using the weight matrix. A numerical example is an activation matrix 550 having 2 rows (T=2) and 3 columns (C_{I}=3). Values of the three columns are (1-3), (7 4), and (2 6). For clarity, the notation of transpose is not shown. The maximum values of the absolute maximum values of the columns are:

$$( 1 - 3 ) \to 3 \\ ( 74 ) \to 7 \\ ( 26 ) \to 6$$

The result for the row vector 515 is a row vector 555=(3 7 6).

The denominator of the ratio in equation (1) can now be determined using the weight matrix 520. The weight matrix 520 has a dimension or shape C_{I}×C_{O}. A maximum operation operates on the rows of the weight matrix 520 to produce a column vector 525. A row vector 522 shows the ΔW vector. To determine the scale term sᵢ in equation (1), first the maximum value of the absolute values of the weight values in the matrix 520 for each channel or row is determined. A numerical example is a weight matrix 550 having 3 rows (C_{I}=3) and 4 columns (C_{O}=4). Values of the three rows are (0 −3 1 4), (2 −7 5 2), and (3 −2 −1 7). For clarity, the notation of transpose is not shown. The maximum values of the absolute maximum values of the rows are:

$$( 0 - 314 ) \to 4 \\ ( 2 - 752 ) \to 7 \\ ( 3 - 2 - 17 ) \to 7$$

The result for the column vector 525 is a column vector 565=(4 7 7).

For illustrative purposes, the hyperparameter α is selected to be 0.5, which when raised to power is equivalent to a square root function. For α=0.5, 1−α is also=0.5. Therefore, the numerator and denominator of the ratio in equation (1) has a square root function. The calculations of the ratio between the vectors 555 and 565 are shown in 567 which gives a result as a row vector 570: (0.867 1.0 0.925), which corresponds to the row vector 540. Accordingly:

$${s}_{i} = ( 0.867 1. 0.925 ) \qquad ( 7 )$$

The smoothed activation matrices \hat{X} and Ŵ computed based on equations (2) and (3). The smoothed activation matrix \hat{X} is determined by dividing each row of the matrix 550 with the scale term 570 element by element. The result is a 2×3 matrix 580. The smoothed weight matrix Ŵ is determined by multiplying the scale term 575, which is the transpose of the row vector 570, with each column of the matrix 560 element by element. The result is a 3×4 matrix 590 as shown.

After the smoothed activation matrix and smoothed weight matrix are determined, the quantization of these matrices can then be carried out by the activation quantizer 320 and weight quantizer 330 as shown in FIG. 3 and FIG. 4.

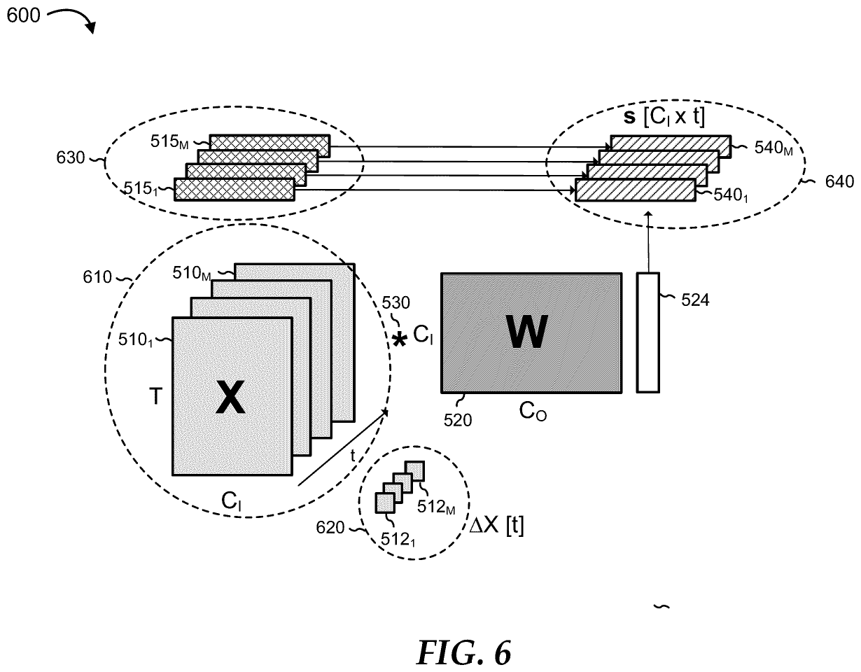

FIG. 6 is a diagram illustrating a representation 600 of a time-step quantization according to an embodiment. The representation 600 illustrates a sequence of video frames where the number of frames is M where M is a positive integer. The representation 600 includes a sequence 610 of activation matrices, a weight matrix 520, an operator 530, a sequence 620 of single elements ΔX, a sequence 630 of activation row vectors, and a sequence 640 of scale terms s. The representation 600 may include more or less than the above elements.

The time-step-wise (TSW) static quantization strategy represented by the representation 600 estimates the quantization parameters for each time step of the denoising process of the diffusion transformer block to handle the time-step=wise variance in activation distributions. The parameters are estimated using a per-step calibration set that is generated from the denoising process given the prompts. When the TSW quantization is used, the bin sizes (ΔX) and zero points (zₓ) for the TW quantization have [1×t] dimensions and the SQ scaling term (sᵢ) has the [C_{I}×t] dimension where t is the number of denoising time steps.

The TSW quantization may have at least three embodiments representing a range of operations. In one embodiment, at one extreme, the TSW quantization operates with different quantization parameters for each diffusion step using a calibration set specifically generated for this operation. In another embodiment, at the other extreme, the TSW quantization operates with single quantization parameters across all steps using a single calibration set that is generated and aggregated across all steps. In yet another embodiment in a general case, the TSW quantization operates with a calibration set for an arbitrary number of steps that is aggregated, and these steps shares the same set of quantization parameters.

The sequence 610 includes M activation matrices 510₁ to 510_{M} along the time step variable t. The sequence 620 includes M elements 512₁ to 512_{M} corresponding to the respective activation matrices 510₁ to 510_{M}. The sequence 630 includes M row vectors 515₁ to 515_{M} corresponding to the respective activation matrices 510₁ to 510_{M}. Each of the matrices 510₁ to 510_{M} is similar to the matrix 510 in FIG. 5. Each of the elements 512₁ to 512_{M} is similar to the element 512 in FIG. 5. Each of the row vectors 515₁ to 515_{M} is similar to the row vector 515 in FIG. 3. The sequence 640 includes M row vectors 540₁ to 540_{M} along the time step variable t. Each of the row vectors 540₁ to 540_{M} is similar to the row vector 540 in FIG. 3. The operator 530 is a matrix multiplication operator. The calculations of the sequence 610, 620, 630 and 640 are performed in a similar manner shown in FIG. 5. The details, therefore, are omitted.

FIG. 7 is a flowchart illustrating a process 700 of quantization according to an embodiment. The process 700 illustrates the process of the operations described in FIGS. 1, 3, and 4. This process assumes that the smooth quantization (SQ) is employed.

Upon START, the process 700 smooths a weight value in the weight matrix and an activation in the activation matrix to generate a smoothed weight value and a smoothed activation value (Block 710). The process 700 may perform the operation in Block 710 on all values in the weight matrix and activation matrix as necessary. The result is the smoothed weight matrix Ŵ and smoothed activation matrix \hat{X} as shown in equations (2) and (3) . . . . If SQ is not needed, this operation may be skipped. Next, the process 700 quantizes a weight matrix of a layer in a diffusion transformer block (Block 720). Ine one embodiment, the layer is one of a spatial self-attention layer, a temporal self-attention layer, a prompt cross attention layer, and a pointwise feed forward layer. Then, the process 700 quantizes an activation matrix of the layer (Block 730). The quantization of the weight and activation matrices includes quantizing in post-training quantization (PTQ) during a calibration period different from an inference period. The quantization of the weight and activation matrices follow the operations shown in FIG. 4. If SQ is done, then quantizing the weight matrix includes quantizing the weight matrix having at least the smoothed weight value to generate a quantized weight matrix, and quantizing the activation matrix includes quantizing the activation matrix having the smoothed activation value to generate a quantized activation matrix.

Next, the process 700 determines if time-step quantization is needed (Block 740). If so (YES at block 740), the process 700 estimates a quantization parameter based on at least one of the quantized weight matrix or the quantized activation matrix for a time step based on a per-step calibration set (Block 750). Then, the process 700 updates the weight and activation matrices (Block 760). This may include updating the quantized values in the memory or memories that store the matrices. The process 700 is then terminated. If time-step quantization is not needed (NO at Block 740), the process 700 proceeds to block 760 and is then terminated.

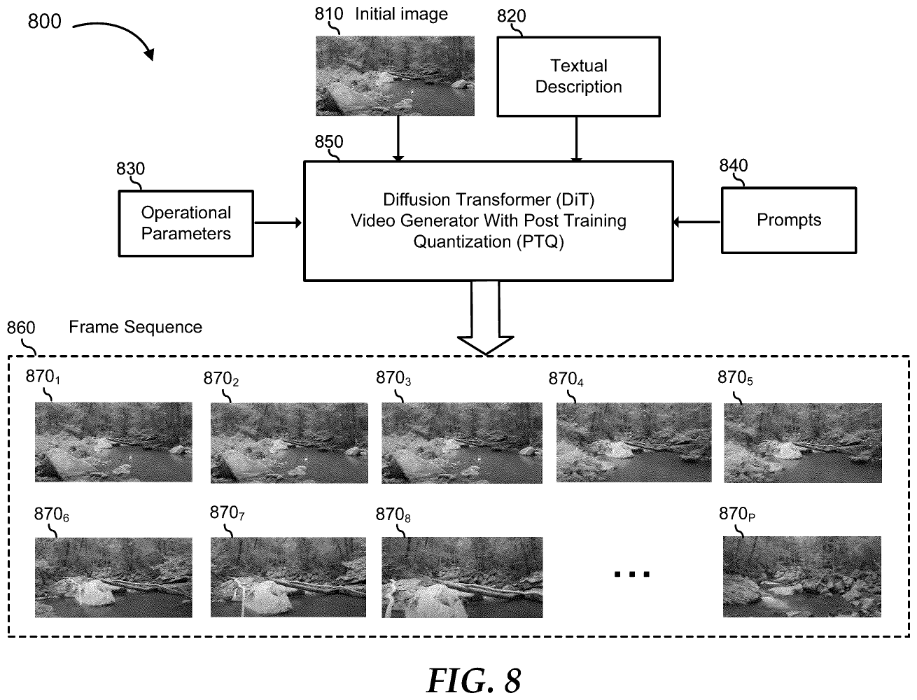

FIG. 8 is a diagram illustrating a system 800 of generating a video using the DiT with PTQ according to an embodiment. The system 800 includes an initial image 810, a textual description 820, operational parameters 830, prompts 840, and a DiT video generator with PTQ 850, and a frame sequence 860. The system 800 may include more or less than the above elements. In the following CW is the channel-wise weight quantization, TW is the tensor-wise activation quantization, SQ is the smooth quantization, and TSW is the time-step wise quantization.

The initial image 810 is the initial spatial representation of the image from which the video generator 850 generate the frame sequence 860. It may include a single image or a set of images. It may be optional if the video generator 850 is configured to generate images based on text description. The initial image 810 shows an example of a scene of a trail along a creek with rocks and fallen tree branches. It may be provided through the user interface 112 in FIG. 1 or stored in memory such as the HBM 210 in FIG. 2. The textual description 820 includes texts that describe the frame sequence 860 of the video. It may be optional if the video generator 850 is configured to generate images based on only the initial image 810. It may be provided through the user interface 112 in FIG. 1 or stored in memory such as the HBM 210 in FIG. 2. In one embodiment, both the initial image 810 and the textual description 820 are used in the vodeo generation. The operational parameters 830 are parameters that are used by the video generator 850 for the video generation. Examples of these parameters include the number P of the frames in the video, the seed for the Gaussian noise generator 130 (in FIG. 1), the bit width b 405 (in FIG. 4), the type of quantization (e.g., CW+TW+SQ+TSW), and the temporal range if the time-step quantization is selected is selected. Prompts 840 are prompts related to the scene or video sequence to guide the video generator to generate images. They are provided through the user interface 112 and the T5 114 and processed by the prompt embedding 116 shown in FIG. 1. Examples of the prompts 840 are “extreme close-up of a trail having a rock, surrounding trees, and a creek flowing through,” and “create a video of a creek flowing through an area having tall pine trees, rocks, and fallen tree branches.” The video generator 850 is the DiT block 100 shown in FIG. 1. It includes the components and quantization functionalities described in FIG. 3. It receives all the inputs including the initial image 810, the textual description 820, the operational parameters 830, the prompts 840, and any other parameters or inputs as necessary to perform its functions. In one embodiment, it generates a video including a frame sequence 860.

The frame sequence 860 includes a sequence of P frames 870₁, 870₂, 870₃, 870₄, 870₅, 870₆, 870₇, 870₈, . . . , and 870_{P}. The sequence shows the scene of a trail along a creek populated with rocks, fallen tree branches, and surrounded by tall pine trees. This sequence is generated from the initial image 810, and the prompts 840. The quantization functionalities by the CW, TW, SQ, and TSW or any combination of them provides fast processing time with high quality images.

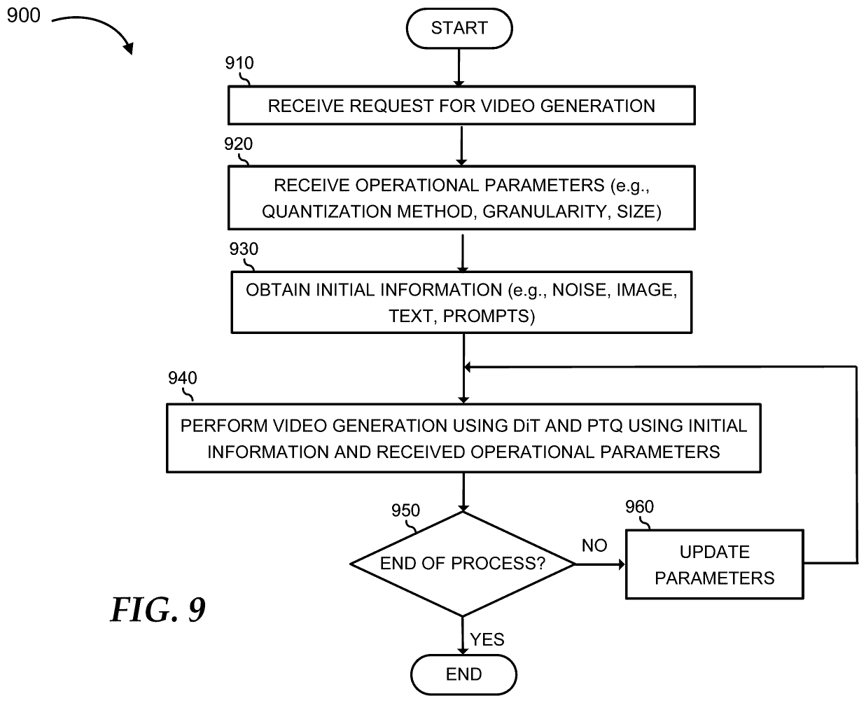

FIG. 9 is flowchart illustrating a process 900 of implementing a video generation using the DiT with PTQ according to an embodiment.

Upon START, the process 900 receives a request for video generation (Block 910). The request may be provided through the user interface 112 shown in FIG. 1 or any other devices through the communication channels 270 shown in FIG. 2. Next, the process 900 receives operational parameters for the DiT video generation (Block 920). Examples of these parameters are the quantization method (e.g., CW, TW, SQ, or TSW), the quantization granularity or the bit width (e.g., INT4, INT8), the size of the video (e.g., the number of frames P). These parameters may be provided through the user interface 112 in FIG. 1 or the communication channels 270 in FIG. 2.

Then, the process 900 obtains the initial information or data (Block 930). This may include the seed for the Gaussian noise generator 130 in FIG. 1, the initial image (e.g., the initial image 810 in FIG. 8), the text (e.g., the textual description 820 in FIG. 8), and the prompts 840 in FIG. 8. Next, the process 900 begins performing the iterative process of video generation including the frame sequence as illustrated in FIG. 8. Then, the process 900 determines if the process is ended or if the iterative process is completed (Block 950). If not, the process 900 updates parameters used in the iterative process (Block 960) and returns to block 940. Otherwise, the process 900 is terminated.

The techniques described in the above various embodiments have practical applications and offer several technical advantages and benefits. The applications and technical advantages are obtained through the weight, activation, smooth, and time-step quantizers. When used together with the diffusion transformers, these quantizers improve the technology in image and video processing.

The generation of images or video using DiT and PTQ has several applications. Some practical applications include the following: (1) media conversions such as text-to-image, text-to-video, or image-to-video, (2) content creation for social media advertisements, training, travels, etc.; (3) video enhancement to improve quality of images; (4) virtual reality and gaming; and (5) film and movie creations for documentaries or entertainment.

The technical advantages include at least the following: (1) fast processing due to integer operations thanks to quantization; (2) reducing memory requirements due to size reduction by the integer format (e.g., INT8) from the floating-point number format (e.g., FP32); (3) maintaining comparable performance or quality of the video images as with the floating-point or dynamic schemes; (4) smoothing out any large variations of the quantization parameters across the channels by the smooth quantizer; and (5) reducing the effects of timestep variance in activation distributions by the time-step quantizer.

All or part of an embodiment may be implemented by various means depending on applications according to particular features, functions. These means may include hardware, software, or firmware, or any combination thereof. A hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. An apparatus comprising:
a weight quantizer configured to quantize a weight matrix of a layer in a diffusion transformer block to generate a quantized weight matrix;
an activation quantizer configured to quantize an activation matrix of the layer to generate a quantized activation matrix; and
a time-step quantizer configured to estimate a quantization parameter based on at least one of the quantized weight matrix or the quantized activation matrix for a time step based on a per-step calibration set.

2. The apparatus of claim 1, further comprising:
a smooth quantizer configured to smooth a weight value in the weight matrix and an activation in the activation matrix to generate a smoothed weight value and a smoothed activation value.

3. The apparatus of claim 2,
wherein the weight quantizer quantizes the weight matrix having the smoothed weight value to generate the quantized weight matrix, and
wherein the activation quantizer quantizes the activation matrix having the smoothed activation value to generate the quantized activation matrix.

4. The apparatus of claim 1,
wherein the weight and activation quantizers quantize the weight and activation matrices, respectively, in post-training quantization (PTQ) during a calibration period different from an inference period.

5. The apparatus of claim 1, wherein the layer is one of a spatial self-attention layer, a temporal self-attention layer, a prompt cross attention layer, and a pointwise feed forward layer.

6. The apparatus of claim 1, wherein the weight quantizer comprises:
a bin size calculator that calculates a bin size based on a weight maximum, a weight minimum, and a bit width; and
a zero calculator that calculates a zero point based on a weight minimum and the bin size.

7. The apparatus of claim 1, wherein the activation quantizer comprises:
a bin size calculator that calculates a bin size based on an activation maximum, an activation minimum, and a bit width; and
a zero calculator that calculates a zero point based on an activation minimum and the bin size.

8. The apparatus of claim 2, wherein the smooth quantizer comprises:
a scaling term calculator that calculates a scaling term based on a ratio between an activation absolute maximum and a weight absolute maximum;
a smoothed weight calculator that calculates the smoothed weight value based on the weight and an inverse the scaling term; and
a smoothed activation calculator that calculates the smoothed activation value based on the activation and the scaling term.

9. The apparatus of claim 4, wherein the time step is grouped into one or more ranges in which the quantization parameter is estimated.

10. The apparatus of claim 6, wherein the bit width is one of 4, 6, 8, or 16.

11. A method comprising:
quantizing a weight matrix of a layer in a diffusion transformer block to generate a quantized weight matrix;
quantizing an activation matrix of the layer to generate a quantized activation matrix; and
estimating a quantization parameter based on at least one of the quantized weight matrix or the quantized activation matrix for a time step based on a per-step calibration set.

12. The method of claim 11, further comprising:
smoothing a weight value in the weight matrix and an activation in the activation matrix to generate a smoothed weight value and a smoothed activation value.

13. The method of claim 12, wherein
quantizing the weight matrix comprises quantizing the weight matrix having the smoothed weight value to generate the quantized weight matrix, and
quantizing the activation matrix comprises quantizing the activation matrix having the smoothed activation value to generate the quantized activation matrix.

14. The method of claim 11,
wherein quantizing the weight and activation matrices comprises quantizing in post-training quantization (PTQ) during a calibration period different from an inference period.

15. The method of claim 11, wherein the layer is one of a spatial self-attention layer, a temporal self-attention layer, a prompt cross attention layer, and a pointwise feed forward layer.

16. The method of claim 11, wherein quantizing the weight matrix comprises:
calculating a bin size based on a weight maximum, a weight minimum, and a bit width; and
calculating a zero point based on a weight minimum and the bin size.

17. The method of claim 11, wherein quantizing the activation matrix comprises:
calculating a bin size based on an activation maximum, an activation minimum, and a bit width; and
calculating a zero point based on an activation minimum and the bin size.

18. The method of claim 12, wherein smoothing comprises:
calculating a scaling term based on a ratio between an activation absolute maximum and a weight absolute maximum;
calculating the smoothed weight value based on the weight and an inverse the scaling term; and
calculating the smoothed activation value based on the activation and the scaling term.

19. The method of claim 14, wherein the time step is grouped into one or more ranges in which the quantization parameter is estimated.

20. A system comprising:
a layer in a diffusion transformer block; and
a layer quantizer configured to quantize the layer, the layer quantizer comprising:
a weight quantizer configured to quantize a weight matrix of a layer in a diffusion transformer block to generate a quantized weight matrix;
an activation quantizer configured to quantize an activation matrix of the layer to generate a quantized activation matrix; and
a time-step quantizer configured to estimate a quantization parameter based on at least one of the quantized weight matrix or the quantized activation matrix for a time step based on a per-step calibration set.
